(19) United States
(12) Patent Application Publication
(10) Pub. No.: US 2006/0252472 A1
(43) Pub. Date: Nov. 9, 2006

(54) Finger mounting for combine header

(75) Inventor: Bernhard Lanzinger, Langenpreising (DE)

Correspondence Address: DEERE & COMPANY, ONE JOHN DEERE PLACE, MOLINE, IL, 61265, US

(73) Assignee: Deere & Company, a Delaware corporation

(21) Appl. No.: 11/400,455

(22) Filed: Jun. 26, 2006

(30) Foreign Application Priority Data
Apr. 13, 2005 (DE) 10 2005 016 976.7

(51) Int. Cl. A01F 12/00

(52) U.S. Cl. 460/20

(57) ABSTRACT

The invention pertains to a driver unit of a rotation-type conveyor with a finger retaining unit that is capable of being arranged in a rotatable manner on an axle segment, and with a finger that is secured by means of retaining devices to the finger retaining unit, and with restraining devices provided on the finger retaining unit for securing the part of the finger that is spatially separated from the finger retaining unit in the event of breakage of the finger. The retaining devices and the restraining devices are constructed in the form of one single component.

### FIELD OF THE INVENTION

The invention pertains to a driver unit of a rotation-type conveyor with a finger retaining unit, which is capable of being arranged in a rotatable manner on an axle segment, and with a finger, which is secured by means of retaining devices to the finger retaining unit, and with restraining devices provided on the finger retaining unit for securing the part of the finger that is spatially separated from the finger retaining unit in the event of breakage of the finger.

### BACKGROUND OF THE INVENTION

Rotation-type conveyors, which are equipped with fingers, find use in harvesting machines in order to haul in or convey material to be harvested. The fingers can break off in the event of excessive stressing or material fatigue, and the part of the finger that becomes detached can cause damage to the components of the harvesting machine. Thus measures have been proposed in the past to secure the various parts of the fingers to the conveyor, wherein account is taken of the breaking off of these parts of the fingers.

A driver unit of a rotation-type conveyor is described in DE 38 40 168 A, wherein a finger retaining unit is mounted on a shaft that is arranged eccentrically with respect to a rotating tube. The finger is connected to the finger retaining unit by means of a screw-type connection, and it has a predetermined breakage location in the form of a groove approximately half way along its length and two bulges that are arranged on the two sides of the groove. An angular retainer has an outer shank with an opening that is pushed over the outer segment of the finger, wherein the diameter of this opening is less than the diameter of the bulge. The inner shank of the finger also comprises an opening through which a screw passes that serves to secure the finger to the finger retaining unit. Consequently, an additional element, namely, the angular retainer, is needed here.

A driver unit is described in EP 10 40 749 A whose finger retaining unit comprises two halves that are connected to one another by means of a swivel joint. The finger is clamped in position between the halves at the lateral end. The halves and the finger are fixed to one another by means of a sheath that is pushed on, and the sheath is secured by means of a cotter pin that passes through holes in the halves and in the finger. No arrangement is provided here for securing the outer part of the finger against detachment.

The problem that forms the underlying basis of the invention is seen in the feature that a rotation-type conveyor driver unit, which is capable of being manufactured in a simple and inexpensive manner, is to be provided in which the outer part of the finger is secured against detachment.

In accordance with the invention, this problem is solved by the teaching of Claim 1, wherein various features, which develop the solution further in an advantageous manner, are listed in the additional claims.

A driver unit of a rotation-type conveyor comprises a finger that is connected to a finger retaining unit by means of retaining devices. It is proposed that the restraining devices, which serve for securing the outer part of the finger in the event of breakage of the finger, be configured in the form of one single component along with the retaining devices, wherein this outer part of the finger is spatially separated from the finger retaining unit. In this way, one reduces the number of parts of the driver unit to be manufactured and to be kept in stock.

In a preferred embodiment, the retaining devices are realized by means of a cotter pin. A first end of the cotter pin passes through an opening that extends through the finger retaining unit and the finger in order to secure the finger to the finger retaining unit. Furthermore, the cotter pin at least partially passes around or surrounds—especially via its second end—the part of the finger that is to be secured against detachment and that is spatially separated from the finger retaining unit.

The situation suggests itself of providing a predetermined breakage location for the finger at a suitable location between the part thereof that is secured to the finger retaining unit and the part thereof that operates in conjunction with the restraining devices in order to ensure that the finger will break at the predetermined breakage location in the event of excessive stressing or material fatigue, and the restraining devices then actually become operational as well.

In addition, it is expedient to provide the finger with a thickened region between the part thereof that is secured to the finger retaining unit, and the part thereof that operates in conjunction with the restraining devices, i.e. the region projects outward relative to the rest of the finger, wherein this region ensures that the restraining devices secure the broken off part of the finger.

In a preferred embodiment, the finger retaining unit is molded in such a way that it has the shape of a closable bearing element, and it comprises two finger retaining unit segments between which the finger is accommodated. The bearing elements are surrounded by a sheath in the region of the finger retaining unit segment, and they are therefore secured to one another. The retaining devices, in turn, fix the sheath in position on the finger retaining unit segment. The retaining devices can be the aforementioned cotter pin, which passes through openings in the sheath, in the finger retaining unit segment, and preferably, though not necessarily, in the finger. In the case of another embodiment, the retaining devices are realized via the sheath itself (see the second embodiment of EP 10 40 749 A), which can then also be molded in such a way that it is in the form of one single component along with a segment that serves as a restraining device.

### BRIEF DESCRIPTION OF THE DRAWINGS

Two embodiments of the invention, which are described in more detail below, are illustrated in the drawings.

FIG. 1 is a schematic lateral view of a cutting unit and of the front part of an oblique conveyor housing of a harvester combine, wherein the cutting unit contains a spiral conveyor in which the invention is realized.

FIG. 2 is a front view in partially sectional form in which the middle part of the spiral conveyor and the arrangement of the fingers are illustrated.

FIG. 3 is a perspective view of a first embodiment of a driver unit.

FIG. 4 is a perspective view of a second embodiment of a driver unit.

### DESCRIPTION OF THE PREFERRED EMBODIMENT

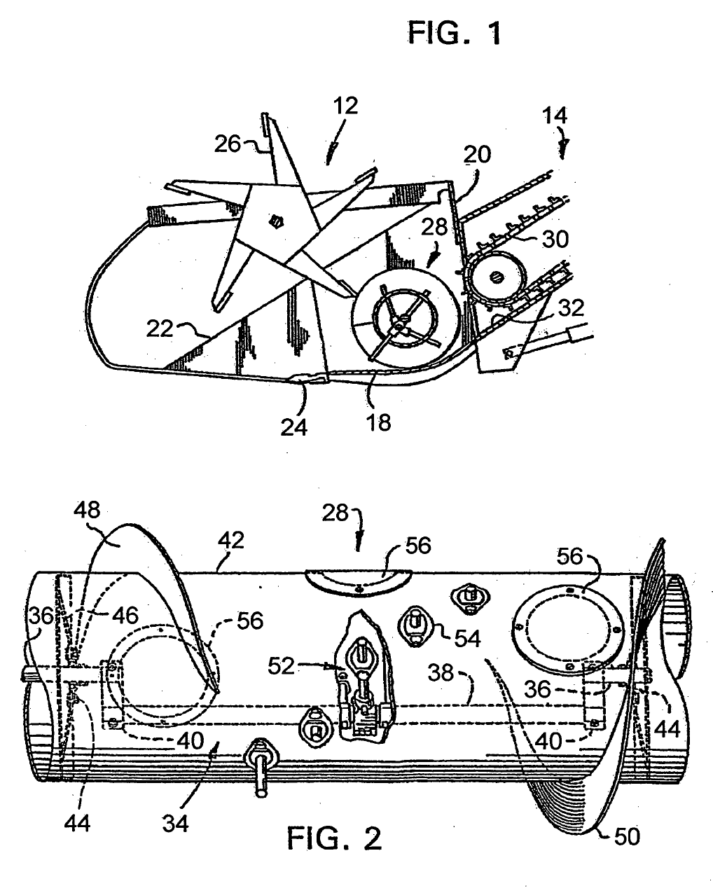

The invention is used in the spiral conveyor of an otherwise conventional cutting unit 12 of a harvester combine that serves for grain harvesting and that is illustrated in the form of a lateral view in FIG. 1. The cutting unit 12 is secured to the oblique conveyor housing 14 of the harvester combine. In its basic assembly, the cutting unit 12 comprises a structure that is open at the front and that has a base 18, a rear wall 20, and lateral parts 22 that are located oppositely. A mowing unit bar 24 extends from the front side of the base 18 in the forward direction and serves for cutting off material for harvesting that is standing upright. A winder 26 is rotated above the bar 24 of the mowing unit and above the front part of the base 18 and operates in conjunction with the spiral conveyor 28 of the cutting unit 12.

The cutting unit 12 is significantly broader than the oblique conveyor housing 14, and the spiral conveyor 28 brings together the harvested material from the bar 24 of the mowing unit and transports it laterally to the middle of the cutting unit 12. There, the material for harvesting is presented to the oblique conveyor housing 14 where it is grasped by the oblique conveyor 30 of the oblique conveyor housing 14, and then it is conveyed toward the rear and upward over the base of the oblique conveyor housing 14 in order to be fed into the threshing drum (not shown) of the harvester combine.

As illustrated in FIG. 2, the spiral conveyor 28 is supported in a rotatable manner by an axle arrangement 34 that has oppositely located coaxial axle segments 36 and a displaced eccentric axle segment 38 that is firmly connected to the axle segments 36 by meas of a pair of arms 40. The axle segments 36, which are located at opposite ends of the spiral conveyor 28, are secured in a rotation-proof manner to the lateral parts 22 of the cutting unit 12 as is known from the prior art though this is not illustrated in the drawings.

The spiral conveyor 28 comprises an elongated cylindrical tube 42 that is mounted in a rotatable manner on the axle segments 36 and concentrically with respect to the axle segments 36 by means of bearing assemblies 44, wherein the bearing assembles 44 supporting elements 46 that are firmly secured to the inside of the tube 42 and that can be star-shaped in particular. Helical conveyor segments 48, 50 of the spiral conveyor 28, which are arranged on the left and the right, operate in conjunction with the base 18 and the rear wall 20 of the cutting unit 12 when the spiral conveyor 28 is rotated, in order that the material being harvested will be conveyed to the middle of the spiral conveyor 28. There, a plurality of driver units 52 are secured to the eccentric axle segment 38. Each finger 60 of a driver unit 52 extends through one of a plurality of guidance assemblies 54 that are secured in the wall of the tube 42. Removable lids 56 permit access to the interior of the tube 42 in order, for example, to service the driver units 52. Suitable conventional drive devices, which are not illustrated in the drawings, are provided in order to rotate the spiral conveyor 28 about the axle segments 36.

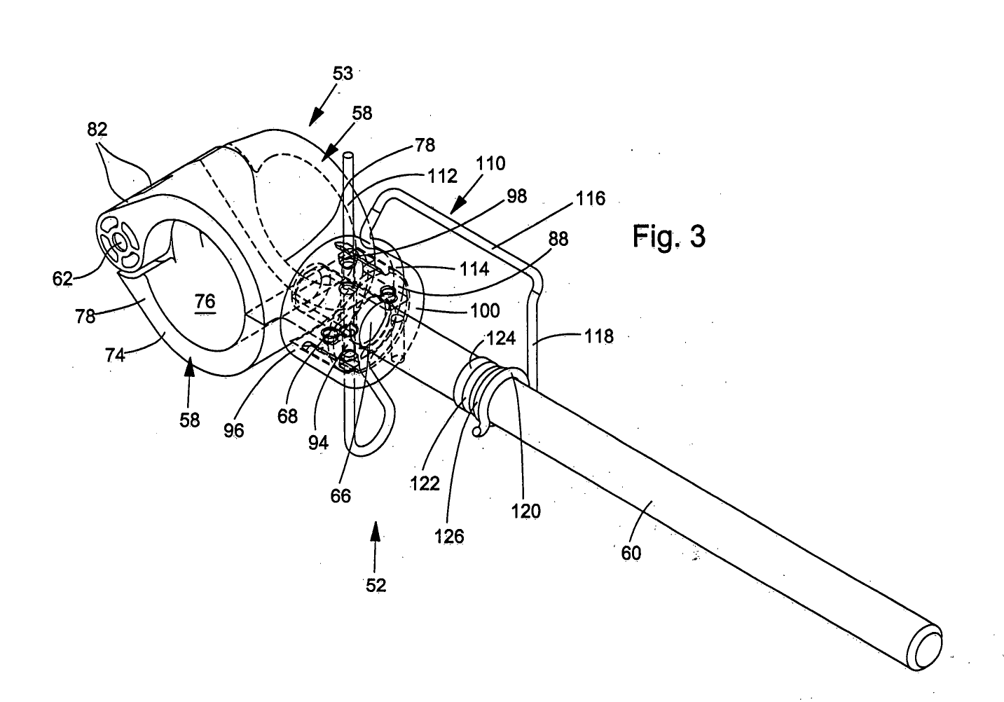

A first embodiment of a driver unit 52 is illustrated in FIG. 3. The driver unit 52 comprises a finger retaining unit 53 that comprises a pair of bearing halves 58 that hold a longitudinally extended finger 60. The two bearing halves 58 are secured to one another by means of a hinge pin 62. The finger 60 has a first (proximal) end segment 66 with a bored out hole 68 that runs through it in a transverse manner, whereby the axis of this bored out hole runs perpendicularly with respect to the longitudinal axis of the finger 60.

Each bearing half 58 comprises a central region that forms a bearing segment 74 that has an internal semicircular bearing surface 76 and parallel ends 78 that are located oppositely. On one side of the bearing segment 74, hinge attachments 82 extend radially onward from the semicircular bearing surface 76. Bored out holes in the hinge attachments 82 are coaxial with respect to one another and parallel to the longitudinal axis of the bearing surface 76. At the opposite side of the bearing segment 74, a finger retaining unit segment 88 extends radially with respect to the semicircular bearing surface 76. A bored out hole 94, which runs transversely, extends through each finger retaining unit segment 88. Each bearing half 58 preferably comprises a hard, shock-resistant material that also ensures a long life for the bearing without lubrication. A polyamide, such as Zytel ST 801, has been used with success.

The movement of the hinge attachments 82 and the arrangement of the bored out holes for the hinge pin 62 are configured in such a way that the bearing surfaces 76 are located opposite one another and facing one another when the two bearing halves 58 are each assembled, wherein the two bearing halves 58 fit together and the hinge pin 62 can be inserted into the bored out holes so that the bearing halves 58 are secured to one another in a rotatable manner via the hinge—that is formed from the hinge pin 62 and bored out hole—and the bearing surfaces 76, which have been joined together, define an approximately cylindrical opening. The bearing halves 58 are preferably identical to one another. It is conceivable that use be made of other forms of coupling than the hinge pin 62 to connect the bearing halves to one another in a manner that permits swiveling, e.g. the two hinge halves to be cast as single component with a single component hinge.

The pivotable bearing of the two bearing halves 58 can be positioned in an opened manner on the eccentric axle segment 38 and then closed. The finger retaining unit segment 88 of each bearing half 58 is symmetrical about an axis that runs perpendicular with respect to the axis of the bearing surface 76. When the bearing halves 58 are joined together, the finger retaining unit segments 88 form a cylindrical socket that accommodates the first (proximal) end segment 66 of the finger 60. The transversely running bored out hole 68 in the finger 60 is aligned with the transversely running bored out hole in the finger retaining unit segments 88.

A sheath 96, which is capable of being moved along the finger 60, is pushed onto the mated finger retaining unit segments 88 of the bearing halves 58. The sheath 96 also has a bored out hole 98 that runs transversely with respect to the transversely running bored out holes 94 in the finger retaining unit segment 88 and is aligned with the transversely running bored out hole 68 in the finger 60. The sheath 96 holds the two bearing halves 58 in a mated position on the eccentric axle segment 38. The sheath 96 has an end wall 100 with an opening in the middle so that the sheath 96 can move on the finger 60.

A cotter pin 110 is inserted through the bored out hole 98 in the sheath 96 and into the bored out holes 94 in the finger retaining unit segments 88 and into the bored out hole 68 in the finger 60. The cotter pin 110 serves for holding the sheath 96 on the finger retaining unit segments 88 in order to ensure that the bearing halves 58 are secured on the eccentric axle segment 38. A second purpose of the cotter pin 110 is to secure the finger 60 to the finger retaining unit segments 88.

In addition to a segment 112, which extends through the bored out holes 68, 94, and 98, the cotter pin 110 comprises a curved segment 114 that is located adjacent to the outside of the sheath 96, and that changes over into a rectilinear segment 116 that extends parallel to the longitudinal axis of the finger 60. At a point approximately one third the way along the length of the finger 60, the latter [segment 116], in turn, changes over into a segment 118 that extends radially with respect to the finger 60 and that finally changes over into a segment 120 that surrounds the finger 60 in an Ω-shaped manner.

In the vicinity of the segment 120 of the cotter pin 110 and between the segment 120 and its first (proximal) end, the finger 60 is equipped with a predetermined breakage location 122 in the form of a groove and two bulge-shaped regions 124, 126 that are arranged on the two sides of the predetermined breakage location 122 and project radially outward.

In the event that the finger 60 should break as a result of material fatigue or excessive stressing, breakage will in all probability take place in accordance with the predetermined breakage location 122. The outer (distal) part that breaks off from the finger 60 is then prevented from exiting from its guidance assembly 54 by the segment 120 of the cotter pin 110 and the bulge 126 so that possible damage to the harvesting machine is avoided.

The cotter pin 110 is preferably a springy locking pin that is inserted manually into the bored-out holes 68, 94, and 98 and then it can be positioned around the finger 60 via the segment 120 and it can also be removed by hand without a manual tool. Thus the fingers 60 and/or the bearing halves 58 can be replaced by hand without manual tools having to be used inside the tube 42. The single component configuration of the cotter pin 110 that serves, on the one hand, as a retaining device for securing the finger 60 to the finger retaining unit 53 and, on the other hand, as restraining device in the event of breakage of the finger 60, reduces the number of parts that are to be manufactured and kept in stock.

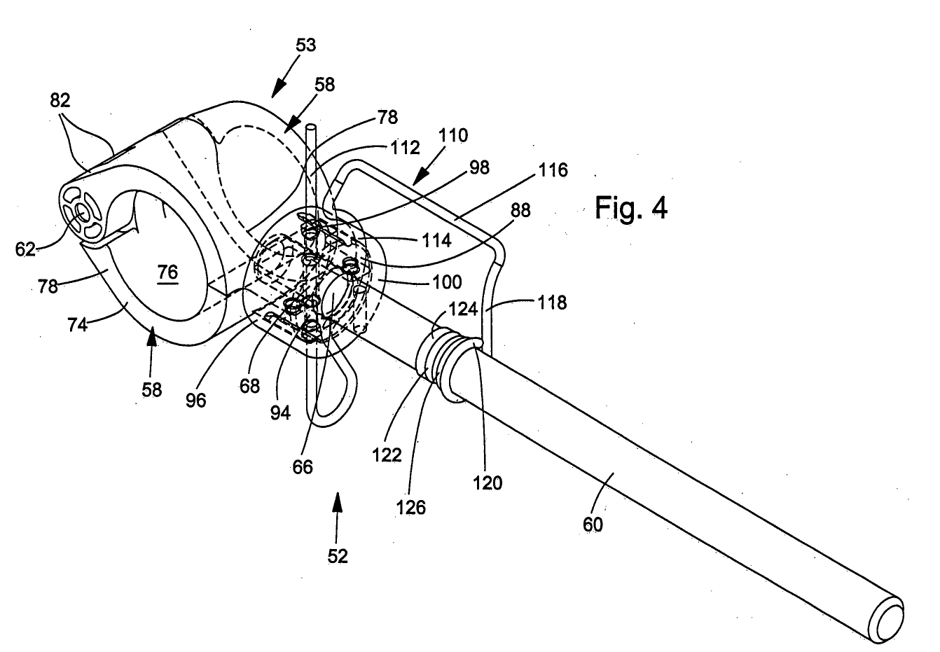

In the case of the embodiment that is illustrated in FIG. 4, use is made of the same reference numbers for those elements that correspond to the first embodiment. The significant difference comprises the feature that the segment 120 passes around the finger 60 in a circular manner.

Having described the preferred embodiment, it will become apparent that various modifications can be made without departing from the scope of the invention as defined in the accompanying claims.

1. A driver unit of a rotation-type conveyor, comprising:
a finger retaining unit capable of being arranged in a rotatable manner on an axle segment;
a finger;
a retaining device for securing the finger to the finger retaining unit; and
a restraining device provided on said finger retaining unit for securing a part of the finger that is spatially separated from the finger retaining unit in the event of breakage of the finger;
wherein the retaining device and the restraining device are constructed in the form of a single component.

2. The driver unit in accordance with claim 1, wherein the retaining device is configured in the form of a cotter pin that extends through an opening, said opening passing through the finger and the finger retaining unit, and wherein said restraining device is configured as a segment that at least partially surrounds the part of the finger that is spatially separated from the finger retaining unit.

3. The driver unit in accordance with claim 1, wherein the finger is equipped with a predetermined breakage location between the part thereof that is adjacent to the finger retaining unit, and the part thereof that operates in conjunction with the restraining device.

4. The driver unit in accordance with claim 1, wherein the finger is equipped with a region, which projects outward relative to the rest of the finger, between the part thereof, which is adjacent to the finger retaining unit, and the part thereof that operates in conjunction with the restraining device.

5. The driver unit in accordance with claim 1, wherein the finger retaining unit is formed in the shape of a closable bearing element, and it has a finger retaining unit segment that configured to accommodate the finger, and wherein a sheath is provided that is equipped for surrounding the finger retaining unit segment of the bearing element and for closing the bearing element, and by the feature that the retaining devices secure the sheath to the finger retaining unit segment.

6. A rotary conveyor, comprising:
(1) a housing that is capable of being moved in rotation and having an opening;
(2) an axle segment that is arranged eccentrically in the housing; and
(3) a driver unit further comprising:
(a) a finger retaining unit arranged on the axle segment,
(b) a finger,
(c) a retaining device for securing the finger to the finger retaining unit; and
(d) a restraining device provided on said finger retaining unit for securing a part of the finger that is spatially separated from the finger retaining unit in the event of breakage of the finger;
(e) wherein the retaining device and the restraining device are constructed in the form of a single component

7. A cutting unit for a harvesting machine comprising:
(1) a frame comprising a base, a rear wall and two lateral walls;
(2) a winder mounted on the frame;
(3) a cutter bar mounted on the frame to cut crop material; and
(4) a spiral conveyor that extends transversely across the frame and further comprises,
(a) a housing that is capable of being moved in rotation and having an opening;
(b) an axle segment that is arranged eccentrically in the housing; and
(c) a driver unit further comprising
(i) a finger retaining unit arranged on the axle segment,
(ii) a finger,
(iii) a retaining device for securing the finger to the finger retaining unit; and
(iv) a restraining device provided on said finger retaining unit for securing a part of the finger that is spatially separated from the finger retaining unit in the event of breakage of the finger,
(v) wherein the retaining device and the restraining device are constructed in the form of a single component
